(19) United States
(12) Patent Application Publication
(10) Pub. No.: US 2010/0175662 A1
(43) Pub. Date: Jul. 15, 2010

(54) INTERNAL COMBUSTION ENGINE CONTROL APPARATUS AND CONTROL METHOD THEREOF

(75) Inventors: Naohide Fuwa, Aichi-ken (JP); Seiko Tamada, Aichi-ken (JP); Hiroyuki Kanemoto, Shizuoka-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/601,634

(22) PCT Filed: May 23, 2008
(86) PCT No.: PCT/IB2008/001309

§ 371 Date: Nov. 24, 2009

(30) Foreign Application Priority Data
May 24, 2007 (JP) 2007-138201

(51) Int. Cl. F02D 11/10; F01L 1/34

(52) U.S. Cl. 123/399; 123/90.15

(57) ABSTRACT

An electronic control unit (60) performs maximum position learning by driving an actuator (50) to move a control shaft (340), and learning the position where stopping occurs because the cylinder head (20) contacts with the Hi end stopper (343) as the movable limit position (Hi end) where the maximum lift amount of the intake valve is largest, to correct the cumulative movement of the control shaft (340). The electronic control unit (60) prevents maximum position learning when the engine speed NE is higher Than a prescribed rotational speed NEst.

### BACKGROUND OF THE INVENTION

1. Field of the Invention

The present invention relates to a control apparatus and a control method for an internal combustion engine equipped with a lift amount change mechanism that changes the maximum lift amount of the intake valve.

2. Description of the Related Art

As a variable valve mechanism that changes the valve characteristics of an internal combustion engine, Japanese Patent Application Publication No. 2005-188286 (JP-A-2005-188286) and Japanese Patent Application Publication No. 2007-187062 (JP-A-2007-187062) discloses a lift amount change mechanism that can change the maximum amount of lift of an intake valve by driving a movable part using an actuator and causing the movable part to move through a prescribed movable range. With this Lift amount change mechanism, the maximum lift amount is highest when the movable part is moved to one movable limit position in the movable range. With a control apparatus for an internal combustion engine equipped with this type of lift amount change mechanism, a base position is set based on the movable limit position where the maximum lift amount of the intake valve is largest, and the maximum lift amount is detected based on the cumulative movement of the movable part from the base position.

Incidentally, if a momentary disruption in the supply of power or, in other words, an instantaneous interruption occurs because of a connection defect or the like in the power line that supplies power to the control apparatus, the cumulative movement of the movable part that is stored in memory will be deleted, and the maximum lift amount will not be able to be determined. Furthermore, if the movable part changes position for some reason while the internal combustion engine is stopped and power is not supplied to the control apparatus so the displacement of the movable part cannot be monitored, a shift can arise between the maximum lift amount determined by the control apparatus and the actual amount of maximum lift.

Therefore, with the control apparatus shown in JP-A-2007-187062, learning is performed to correct the cumulative movement of the movable part. Specifically, the movable part is moved by a fixed driving force, and the cumulative movement is corrected by learning the position at which the movable part stops as the movable limit position, thereby correcting the shift between the maximum lift amount determined by the control apparatus and the actual maximum lift amount.

Incidentally, when the movable part is driven in the direction that increases the maximum lift amount of the intake valve and the position at which the movable part stops is learned as the movable limit position (hereinafter referred to as maximum position learning), the reactive force received from the valve spring of the intake valve will successively increase as the maximum lift amount increases. Therefore, a strong driving force is required to perform maximum position learning. In addition, the loss of driving force due to vibration of the various parts in the lift amount change mechanism that occurs during valve lifting, the loss in the driving force due to the reactive force from the valve spring, and the Like is larger when engine speed is higher where the number of valve lifts per unit of time is large. Therefore, at high engine speeds, an even stronger driving force is required for the maximum position learning. As a result, there is a possibility that the driving force for the actuator becomes insufficient, the movable part stops prematurely, and this stopped position is inadvertently learned to be the movable limit position.

Furthermore, it is conceivable to set the driving force to a large value before performing the maximum position learning in order to surely perform the maximum position learning even at high engine speeds. However, when performing the maximum position learning, the cumulative movement of the movable part cannot be accurately determined, and thus the distance to the movable limit position cannot be accurately determined. Therefore, when the lift amount change mechanism is driven by a large driving force, the impact that occurs when the movable part reaches the movable Limit position will be extremely high. As a result, there is a possibility of causing damage to the lift amount change mechanism and to the actuator that drives the lift amount change mechanism. Therefore, there is an inherent limit to the degree that the driving force of the actuator can be increased during the maximum position learning, and room for improvement remains from this perspective.

### SUMMARY OF THE INVENTION

The present invention provides an internal combustion engine control apparatus that can reduce the occurrence of mistaken learning caused by insufficient driving force during the maximum position learning.

One aspect of the invention relates to an internal combustion engine control apparatus having a lift amount change mechanism that moves a movable part by means of an actuator and changes the maximum lift amount of an intake valve; a detecting means that sets a base position based on a movable limit position where the maximum lift amount is largest and detects the maximum lift amount based on the cumulative movement of the movable part from the base position; and a learning means that drives the actuator such that the maximum lift amount becomes higher and performs the maximum position learning to correct the cumulative movement by learning the position where the movable part stops as the movable limit position. This internal combustion engine control apparatus has a forbidding means that forbids the maximum position learning to be performed by the learning means when the engine speed is above a prescribed rotational speed.

The control apparatus may further include a temperature estimating means that estimates the temperature of the actuator, and the prescribed rotational speed may be set to a smaller value when the temperature of the actuator estimated by the temperature estimating means is lower.

The temperature estimating means may estimate the temperature of the actuator based on the engine coolant temperature.

Furthermore, the temperature estimating means may estimate the temperature of the actuator based on the internal combustion engine air intake cumulative value during the latest prescribed time period.

Specifically, the temperature estimating means may use the engine coolant temperature as a correlation value related to the actuator temperature, and estimate that the actuator temperature is high when the engine coolant temperature is high.

Furthermore, although the temperature of the internal combustion engine vanes because of the heat of combustion, the heat of combustion will vary according to the amount of air intake, and therefore the internal combustion engine air intake cumulative value during the latest prescribed time period may be used as a correlation value related to the temperature of the actuator to estimate that the temperature of the actuator is high when this cumulative value is high.

Incidentally, the fuel injected cumulative value has a strong correlation to the intake air cumulative value, and this may also be used.

The control apparatus may further include a limiting means that limits the driving force of the actuator during the maximum position learning.

### BRIEF DESCRIPTION OF THE DRAWINGS

The foregoing and further objects, features and advantages of the invention will become apparent from the following description of embodiments with reference to the accompanying drawings, wherein like numerals are used to represent like elements and wherein:

FIG. 1 is a cross-section view showing a construction of a valve mechanism according to an embodiment of the invention;

FIG. 2 is a cutaway perspective view of a lift amount change mechanism of the same embodiment;

FIG. 3 is a schematic view showing a basic construction of an actuator for the lift amount change mechanism and a control apparatus for the same embodiment;

FIGS. 4A to 4D are timing charts showing the transition of output signals from position sensors, position count value and stroke count value in conjunction with the rotation of a brushless motor;

FIG. 5 is a table showing the relationship between the output signals of position sensors and the increase or decrease in the position count value for the same embodiment;

FIGS. 6A to 6C are descriptive diagrams showing the relationship between the control shaft position and the stroke count value, where FIG. 6A shows the case at normal time. FIG. 6B shows the case at instantaneous interruption time, and FIG. 6C shows the case when learning;

FIG. 7 is a flowchart showing the flow for a limiting process series for the same embodiment;

FIG. 8 is a graph showing the relationship between the actuator temperature and the prescribed rotational speed; and

FIG. 9 is a graph showing the relationship between engine speed and the required driving force for the maximum position learning.

### DETAILED DESCRIPTION OF THE EMBODIMENTS

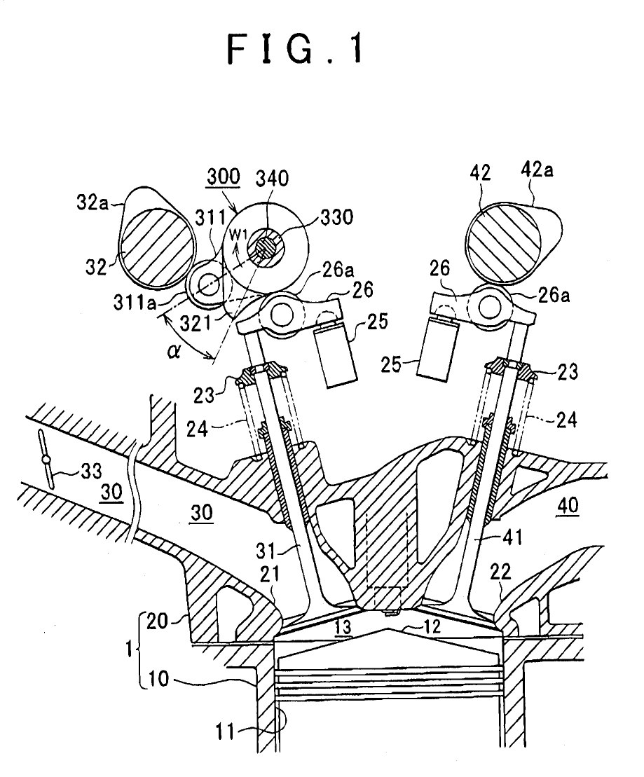

A specific embodiment of the internal combustion engine control apparatus of the present invention is described below while referring to FIGS. 1 to 9. FIG. 1 is a cross-section view showing the construction of an internal combustion engine valve mechanism according to the present embodiment. As shown in FIG. 1, an engine main body 1 of an internal combustion engine is constructed by assembling a cylinder block 10 and a cylinder head 20. A cylinder 11 formed in the cylinder block 10 contains a piston 12 in a mariner such that the piston 12 can slide. Furthermore, the cylinder head 20 is attached to the top part of the cylinder block 10, and a combustion chamber 13 is demarcated and formed by the inner circumferential surface 11 of the cylinder, the upper surface of the piston 12, and the bottom surface of the cylinder bead 20.

An intake port 21 and an exhaust port 22 connected to the combustion chamber 13 are formed in the cylinder head 20. The intake port 21 is connected to an intake manifold not shown in the drawings, and forms a part of an intake channel 30. Furthermore, the exhaust port 22 is connected to an exhaust manifold not shown in the drawings, and forms a part of an exhaust channel 40. Incidentally, a throttle valve 33 that regulates the amount of air that is introduced into the combustion chamber 13 is provided in the intake channel 30.

An intake valve 31 that connects and disconnects the intake channel 30 and the combustion chamber 13 and an exhaust valve 41 that connects and disconnects the exhaust channel 40 and the combustion chamber 13 are formed in the cylinder head 20 as shown in FIG. 1. A retainer 23 is attached to each of these valves 31, 41, and a valve spring 24 is provided between the cylinder head 20 and these retainers 23. Thereby, each valve 31, 41 is urged toward the closed valve direction by an urging force of the valve spring 24.

Furthermore, a lash adjuster 25 corresponding to each valve 31, 41 is provided inside the cylinder head 20, and a rocker arm 26 extends between the lash adjustor 25 and each valve 31, 41. As shown in FIG. 1, the rocker arm 26 is supported on one end by the lash adjustor 25, and the other end is in contact with the base end of each valve 31, 41.

Furthermore, an intake camshaft 32 and an exhaust camshaft 42 that drive both valves 31, 41 are rotatably supported in the cylinder head 20. Intake earns 32a are formed on the intake camshaft 32 and exhaust cams 42a are formed on the exhaust camshaft 42. The outer circumferential surface of the exhaust cam 42a contacts a roller 26a on the rocker arm 26 that is in contact with the exhaust valve 41. Therefore, when the exhaust camshaft 42 rotates during engine operation, the rocker arm 26 pivots by the action of the exhaust cam 42a with the section supported by the lash adjustor 25 as a fulcrum. As a result, the exhaust valve 41 lifts in the direction of opening the valve because of the rocker arm 26.

On the other hand, a lift amount change mechanism 300 is provided between the intake cam 32a and the rocker arm 26 that is in contact with the intake valve 31. This lift amount change mechanism 300 has an input arm 311 and an output arm 321, and the input arm 311 and output arm 321 are supported by a support pipe 330 so as to be able to oscillate about the support pipe 330 that is attached to the cylinder head 21. The rocker arm 26 is urged toward the output arm 321 side by the urging force of the valve spring 24, and the roller 26a provided in the middle section of this rocker arm 26 is in contact with the outer circumferential surface of the output arm 321. Thereby, the lift amount change mechanism 300 is urged in a clockwise direction WI as shown in FIG. 1, and a roller 311a provided at the leading end of the input arm 311 is pressed against the outer circumferential surface of the intake cam 32a. Therefore, when the intake cam 32a rotates during engine operation, the lift amount change mechanism 300 pivots by the action of the intake cam 32a around the support pipe 330. In addition, the rocker arm 26 pivots with the section supported by the lash adjustor 25 as a fulcrum by the action of the output arm 321, and as a result, the intake valve 31 is lifted in the direction of valve opening by the rocker arm 26.

Furthermore, a control shaft 340 is inserted in the support pipe 330 movably along the axial direction. The lift amount change mechanism 300 can change the relative phase difference or, in other words, angle a shown in FIG. 1 between the input arm 311 and the output arm 321 with the support pipe 330 at the center by shifting the control shaft 340 in the axial direction.

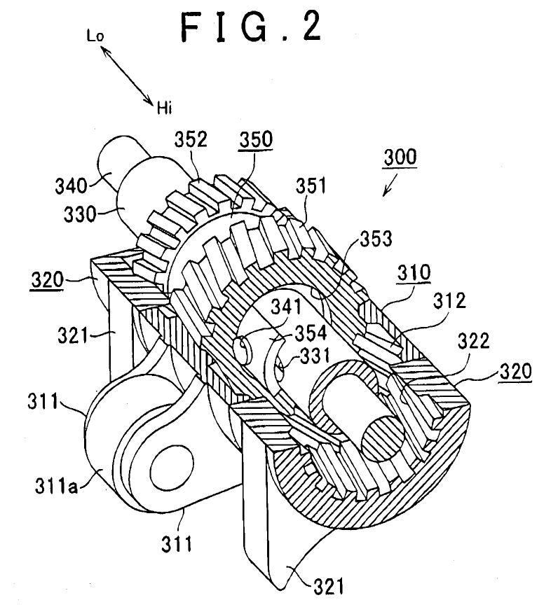

Next, the construction of the lift amount change mechanism 300 will be described in detail while referring to FIG. 2. Incidentally, FIG. 2 is a cutaway perspective view showing the internal construction of the lift amount change mechanism 300. The control shaft 340 is inserted so as to be able to move in the axial direction as shown in FIG. 2 into the support pipe 330 that is attached to the cylinder bead 20. Furthermore, a cylindrical slider 350 is fit over the support pipe 330 so as to be able to move in the axial direction.

A groove 353 that extends in the circumferential direction is formed in the inner wall of the cylindrical slider 350, and a bushing 354 is mated with this groove 353. Furthermore, a long hole 331 that extends in the axial direction is formed in the pipe wall of the support pipe 330, and a locking pin 341 that passes through the long hole 331 and connects the slider 350 and the control shaft 340 is provided between the slider 350 and the control shaft 340. Furthermore, one end of the locking pin 341 is inserted into a recess (not shown in the drawings) formed in the control shaft 340, and the other end is inserted into a through hole formed in the bushing 354. Thereby, the slider 350 will pivot freely around the support pipe 330 and the control shaft 340 and will move in the axial direction in conjunction with the control shaft 340.

Furthermore, helical splines 351 are formed in the center region of the outer circumferential surface of the slider 350, and helical splines 352 with a thread line inclined in the opposite direction as the helical splines 351 are formed on both sides.

As shown in FIG. 2, a pair of output parts 320 are attached over the outside of the slider 350 and are positioned so as to sandwich the input part 310. Helical splines 312 are formed in the inner circumferential surface of the input part 310, and the helical splines 312 mate with the helical splines 351 of the slider 350. Furthermore, a pair of input arms 311 is formed to protrude in the radial direction of the control shaft 340 from the outer circumferential surface of the input part 310, and the roller 311a is rotatably supported between this pair of input arms 311.

On the other hand, helical splines 322 are formed in the inner circumferential surface of the pair of output parts 320, and these helical splines 322 both mate with the helical splines 352 of the slider 350. Furthermore, output arms 321 are formed to protrude in the radial direction of the control shaft 340 on the outer circumferential surface of the output part 320.

With this type of lift amount change mechanism 300, when the control shaft 340 moves along the axial direction, the slider 350 moves in conjunction in the axial direction. The helical splines 351, 352 formed on the outer circumferential surface of the slider 350 are mated with the helical splines 312, 322 that are formed in the inner circumferential surface of the input part 310 and the output part 320, and therefore when the slider 350 moves in the axial direction, the input part 310 and the output part 320 will rotate in the opposite directions. As a result, the relative phase difference between the input arm 311 and the output arm 321 is changed, and the maximum lift amount of the intake valve 31 is changed. Specifically, when the control shaft 340 is moved in the direction of the Hi arrow shown in FIG. 2, the control shaft 340 and the slider 350 will move in the Hi direction. In conjunction, the relative phase difference between the input arm 311 and the output arm 321 or, in other words, angle a in FIG. 1, will increase, and the maximum lift amount of the intake valve 31 will increase. On the other hand, when the control shaft 340 is moved in the direction of the Lo arrow shown in FIG. 2, the control shaft 340 and the slider 350 will move in the Lo direction, and the relative phase difference between the input arm 311 and the output arm 321 will decrease, and thus the maximum lift amount of the intake valve 31 will decrease.

With the internal combustion engine of the present embodiment, the throttle valve 33 established in the intake channel 30 will remain in a completely open condition during engine operation, and the amount of air intake is regulated by changing the maximum lift amount of the intake valve 31 using the lift amount change mechanism 300.

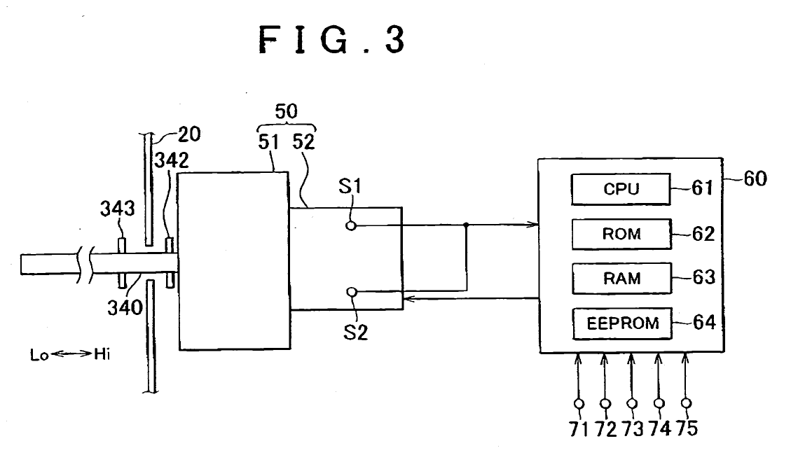

Next, the drive mechanism for moving the control shaft 340 in the axial direction and the control of the drive mechanism will be described while referring to FIGS. 3 to 6. FIG. 3 is a schematic view showing a basic construction of an actuator and control apparatus for the lift amount change mechanism 300. As shown in FIG. 3, as an actuator 50, a brushless motor 52 is connected through a transfer mechanism 51 to the base end (right end shown in FIG. 3) of the control shaft 340. The rotational movement of the brushless motor 52 is convened to linear motion in the axial direction of the control shaft 340 by the transfer mechanism 51. Furthermore, the control shaft 340 moves in the axial direction and drives the lift amount change mechanism 300 using rotational drive within a prescribed rotational angle range of the brushless motor 52, for example, within a rotational angle range of 10 rotations (0 to 3600°) of the brushless motor 52.

Incidentally, when the brushless motor 52 is rotated in the forward direction, the control shaft 340 moves in the direction of the Hi arrow in FIG. 3, and as described above, the relative phase difference between the input arm 311 and the output arm 321 of the lift amount change mechanism 300 will increase. Furthermore, the movement of the control shaft 340 in the Hi arrow direction is restricted by a Hi end stopper 343 provided on the control shaft 340. The position where the Hi end stopper 343 contacts with a part of the cylinder head 20 is the movable limit position (hereinafter referred to as the Hi end) where the maximum lift amount of the intake valve 31 is largest.

On the other hand, when the brushless motor 52 is rotated in the backward direction, the control shaft 340 moves in the direction of the Lo arrow in FIG. 3, and the relative phase difference between the input arm 311 and the output arm 321 will decrease. The movement of the control shaft 340 in the direction of arrow Lo is restricted by a Lo end stopper 342 provided on the control shaft 340. The position where the Lo end stopper 342 contacts with a part of the cylinder head 20 is the movable limit position (hereinafter referred to as the Lo end) where the maximum lift amount of the intake valve 31 is smallest.

The control shaft 340 is moved in the axial direction in this manner, whereby the maximum lift amount of the intake valve 31 varies depending on the position of the control shaft 340 in the axial direction. Furthermore, the position of the control shaft 340 in the axial direction varies depending on the rotational angle within the prescribed rotational angle range of the brushless motor 52.

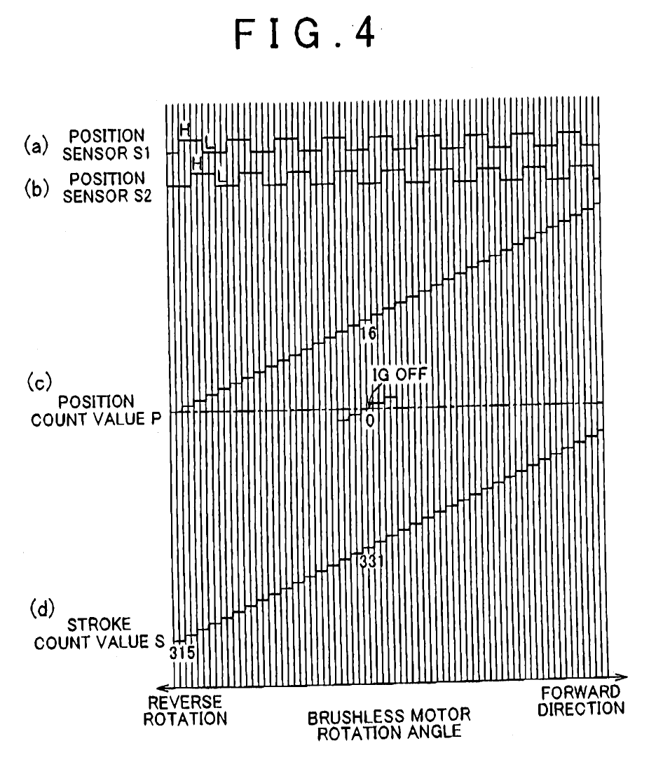

The brushless motor 52 has two position sensors S1, S2, Each of the position sensors S1, S2 alternately outputs a pulse signal or, in other words, a high signal “H” and a low signal “L” as shown in FIG. 4A and FIG. 4B, corresponding to a change in the magnetic flux of a 48-pole multipolar magnet that integrally rotates with a rotor of the brushless motor 52 when the brushless motor 52 rotates. Note, FIG. 4 is a timing chart showing the transition of the signals from the position sensors S1, S2, the position count value P, and the stroke count value S in conjunction with the rotation of the brushless motor 52.

Furthermore, the pulse signals from the position sensors S1, S2 are output in mutually shifted phases, and during forward rotation, the rising edge and descending edge of the pulse signal from the position sensor S1 occur prior to the rising edge and descending edge of the pulse signal from the position sensor S2. Note, an edge of the pulse signal output from either one of the position sensors S1, S2 is generated for each rotation of 7.5° by the brushless motor 52. Furthermore, the pulse signal from one sensor is generated with a phase that is shifted by a rotation of 3.75° of the brushless motor 52 with regards to the pulse signal from the other sensor. Therefore, the interval between the edges of the pulse signals from the position sensors S1, S2 is 3.75°.

As shown in FIG. 3, the signal from the position sensors S1, S2 is received by an electronic control unit 60 that comprehensively controls the internal combustion engine. Furthermore, the electronic control unit 60 drives and controls the brushless motor 52 based on the signals. The electronic control unit 60 includes a central processing unit (CPU) 61, a read-only memory (ROM) 62, a random access memory (RAM) 63, an EEPROM 64, which is a non-volatile memory where stored data can be rewritten, and the like.

The CPU 61 performs operations related to controlling the amount of fuel injected and the ignition timing, and also performs various operations related to driving the Lift amount change mechanism 300 or, in other words, driving the brushless motor 52. Specifically, the position of the control shaft 340 is detected based on the signals from the position sensors S1, S2. Furthermore, the target position of the control shaft 340 suitable for the running conditions of the engine detected by the various sensors, which will be discussed later, is calculated, and the drive of the brushless motor 52 is controlled so that the position of the control shaft 340 matches this target position. The various control programs and the like are stored beforehand in the ROM 62. The RAM 63 is a volatile memory that requires a battery backup to retain the memory data, and temporarily stores the operation results and the like of the CPU 61. The EEPROM 64 is a memory where the stored data can be electrically rewritten, and does not require a battery backup to retain the stored data.

The electronic control unit 60 is connected to an accelerator sensor 71 that detects the amount that the accelerator pedal is pressed down by the operator (accelerator operation amount ACCP), a throttle sensor 72 that detects the degree of opening of the throttle valve 33 (throttle opening degree TA) established in the intake channel 30, an airflow meter 73 that detects the amount of air that passes through the intake channel 30 and is drawn into the combustion chamber 13 or, in other words, the amount of air intake GA, a crank angle sensor 74 that detects the engine speed NE, a water temperature sensor 75 that detects the engine coolant temperature THW, and the like, and the electronic control unit 60 receives a signal from each of these sensors 71-75.

The electronic control unit 60 drives and controls the brushless motor 52 based on the difference between the target position, which is calculated based on the signals from the various sensors 71-75 as described above and the detected position of the control shaft 340. Therefore, the position of the control shaft 340 must be accurately detected in order to precisely control the maximum lift amount of the intake valve 31.

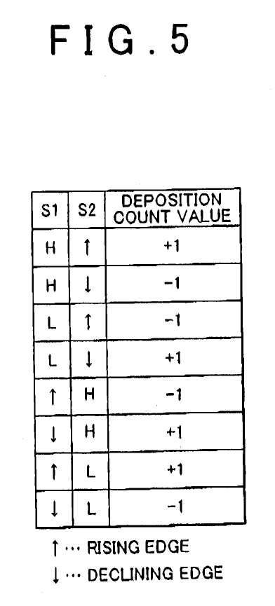

Next, the method of detecting the position of the control shaft 340 in the axial direction is described in detail while referring to FIGS. 4 and 5 together. Note, FIG. 5 is a table showing the relationship between the signal from each of the position sensors S1, S2 and the increase or decrease in the position count value P.

As described above, (a) and (b) of FIG. 4 show the output pattern of the pulse signal output from each of the position sensors S1, S2 when the brushless motor 52 rotates. Furthermore, (c) and (d) of FIG. 4 show the transition of the position count value P and the stroke count value S in conjunction with the rotation of the brushless motor 52. Note, the position count value P corresponds to the cumulative movement showing bow the position of the control shaft 340 in the axial direction has changed or, in other words, how far the control shaft 340 has moved from the base position in conjunction with the rotation of the brushless motor 52 after the ignition switch has been turned on (IG ON) when starting the internal combustion engine. Furthermore, the stroke count value S is calculated based on the standard value Sst that shows the base position and on the position count value P, and expresses the position of the control shaft 340 in the axial direction. Note, the standard value Sst is the stroke count value S when the previous engine operation was completed, and this value is stored in EEPROM 64 after completing the engine operation.

When detecting the position of the control shaft 340, first, the position count value P is increased or decreased for each edge of the pulse signal based on the output pattern of the pulse signal from each of the position sensors S1, S2. In detail, as shown in FIG. 5, either “+1” or “−1” is added to the position count value P based on whether a rising edge or a descending edge is being formed by the pulse signal from either one of the position sensors S1, S2 and whether a Hi signal “H” or a Lo signal “L” is being output from the other sensor. Note, in FIG. 5, the up arrow “↑” represents the pulse signal rising edge, and the down arrow “↓” represents the pulse signal descending edge. The position count value P thus obtained is a value representing the total number of edges of the pulse signals from the position sensors S1, S2.

When the brushless motor 52 is rotating in a forward direction, the position count value P is increased by “1” for each edge of the pulse signals from the position sensors S1, S2, as shown in FIG. 4C. Furthermore, when the brushless motor 52 is rotating in the reverse direction, the position count value P will be decreased by “1” for each edge. Note, the position count value P is stored in the RAM 63 of the electronic control unit 60, so when the ignition switch is turned off (IG OFF) and the power supplied to the RAM 63 is halted, the position count value P will be reset to “0” as shown in FIG. 4C.

When the position count value P is calculated in this manner, the CPU 61 calculates the stroke count value S based on the standard value Sst stored in the EEPROM 64 and the calculated position count value P. Specifically, the position count value P is added to the standard value Sst stored beforehand in EEPROM 64, and the value obtained is calculated as the new stroke count value S. In this manner, the position of the control shaft 340 is detected when the stroke count value S is updated.

Therefore, as shown in FIG. 4D, when the brushless motor 52 is rotating in the forward direction, the stroke count value S increases in line with an increase in the position count value P. On the other hand, when the brushless motor 52 is rotating in the reverse direction, the stroke count value S decreases in line with a decrease in the position count value P.

When the stroke count value S is calculated, the electronic control unit 60 compares the stroke count value S to the target stroke count value Sp as the target position for the control shaft 340. Furthermore, the brushless motor 52 is driven and controlled to rotate or, in other words, the lift amount change mechanism 300 is driven and controlled so that the calculated stroke count value S matches the target stroke count value Sp.

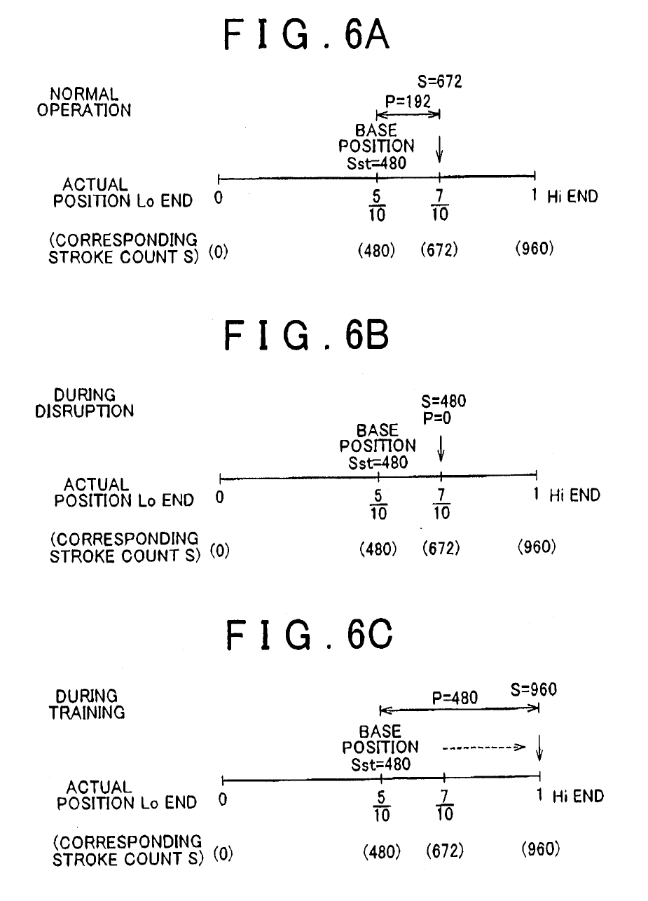

The relationship between the stroke count value S when the position of the control shaft 340 is detected and the actual position of the control shaft 340 for the present embodiment is described below in detail while referring to FIG. 6.

FIGS. 6A to 6C are descriptive diagrams showing the relationship between the stroke count value S and the actual position of the control shaft 340 when the lift amount change mechanism 300 is driven in the movable range corresponding to 10 rotations (0 to 3600°) of the brushless motor 52.

With the internal combustion engine of the present embodiment as described above, the position count value P and the stroke count value S are both increased by “1” each time the brushless motor 52 rotates 3.75°. Therefore, if the stroke count value S corresponding to the Lo end is “0”, the value for the stroke count value S corresponding to the Hi end will be “960”. The case in which the base position is a middle position between the Lo end and the Hi end (Sst=480) is described below.

For example, as shown in FIG. 6A, when the control shaft 340 is driven toward the Hi end by the distance equivalent to two rotations) (720°) of the brushless motor 52 and moved from the base position to the position shown by the arrow, the position count value P will be “192”, and the stroke count value S will be “672”. Therefore, if the distance from the Lo end to the Hi end is “1”, the control shaft 340 will be detected at a position of “672/960” toward the Hi end or, in other words, at position “7/10”.

Incidentally, if the power supply is temporarily disrupted causing a so-called instantaneous interruption to occur because of a connection defect or the like with the power line that supplies power to the electronic control unit 60, the position count value P that is stored in the RAM 63 is deleted in some cases. When the position count value P is deleted because of such an instantaneous interruption, if, for example, the position count value P becomes the initial value “0”, the stroke count value S or, in other words, the position of the control shaft 340 as determined by the electronic control unit 60 will be shifted from the actual position of the control shaft 340.

Specifically, if the position count value P becomes “0” because of an instantaneous interruption, the stroke count value S becomes “480” even though the control shaft 340 is actually in a position “7/10” towards the Hi end as shown by the arrow in FIG. 6B. Therefore, the electronic control unit 60 will mistakenly determine that the control shaft 340 is at the base position or, in other words, at a middle position between the Lo end and the Hi end.

If the position of the control shaft 340 is mistakenly detected in this manner, the amount of air intake GA will be estimated based on the mistakenly detected position and will deviate from the actual amount of air intake GA. In addition, if the lift amount change mechanism 300 continues to be driven in this condition, for example, there is a possibility that the amount of fuel injection set by the electronic control unit 60 will be largely shifted from the amount of fuel injection that corresponds to the actual amount of air intake GA, and the actual air-fuel ratio will deviate greatly from the air-fuel ratio that provides favorable exhaust conditions.

Furthermore, in order to prevent the position count value P from being deleted by an instantaneous interruption, it is conceivable to use a construction where the value for the position count value P is stored in EEPROM 64 which does not require a battery backup to retain the stored data. However, EEPROM 64 is limited in the number of times that the stored data, can be rewritten and if the position count value P which successively changes is stored while the control shaft 340 is being driven, durability will be dramatically reduced, and therefore use of this type of construction is not practical.

Thus, with the internal combustion engine of the present embodiment, problems that occur as a result of the position count value P being deleted are suppressed by performing the maximum position learning as described below.

If the position count value P is deleted because of an instantaneous interruption, the control shaft 340 will be moved to the Hi end by a fixed driving force as shown by the broken line arrow in FIG. 6C. Furthermore, the position where the Hi end stopper 343 contacts the cylinder head 20 and movement of the control shaft 340 is stopped will be learned as the Hi end. Specifically, the value for the position count value P will be set to “480” so that the stroke count value S will be “960” at this position. Note, during the maximum position learning, the amount of air intake GA is regulated by the throttle valve 33. Specifically, the opening degree of the throttle valve 33 is adjusted and the amount of air intake GA is regulated corresponding to the accelerator operation amount ACCP so that the throttle opening degree TA will increase as the accelerator operation amount ACCP increases.

Therefore, the deviation between the position of the control shaft 340 as determined by the electronic control unit 60 and the actual position of the control shaft 340 can be eliminated by performing the maximum position learning in which the control shaft 340 is driven to the Hi end and the position of stopping is learned as the Hi end.

Note, under conditions where the position count value P is deleted because of an instantaneous interruption, the position of the control shaft 340 cannot be accurately determined, and the distance to the Hi end cannot be accurately determined. Therefore, if the control shaft 340 is driven by a large driving force, the impact when the Hi end stopper 343 contacts the cylinder head 20 and stops moving will be extremely large, and there is a possibility that the lift amount change mechanism 300, the brushless motor 52, or the transfer mechanism 51 will be damaged. Therefore, with the present embodiment, the driving force of the brushless motor 52 is restricted during the maximum position learning, and the control shaft 340 is driven by a driving force that is approximately half of the driving force that can be generated by the brushless motor 52. Therefore, damage to the lift amount change mechanism 300, the brushless motor 52, and the transfer mechanism 51 can be suppressed.

Incidentally, when the control shaft 340 is moved to the Hi end, the reactive force received from the valve spring 24 will successively increase as the maximum lift amount increases. Therefore, the maximum position learning where the control shaft 340 is moved to the Hi end requires a strong driving force. In addition, the loss due to vibration of the various parts in the lift amount change mechanism 300 that occurs during valve lifting and the loss in the driving force due to the reactive force and the like from the valve spring 24 will increase at higher engine speeds where the number of valve lifts per unit of time increases, and therefore an even larger driving force is required in order to perform the maximum position learning at high engine speeds. As a result, there is a possibility that the driving force becomes insufficient during the maximum position learning, the control shaft 340 stops prematurely, and this stopping position is inadvertently learned to be the Hi end.

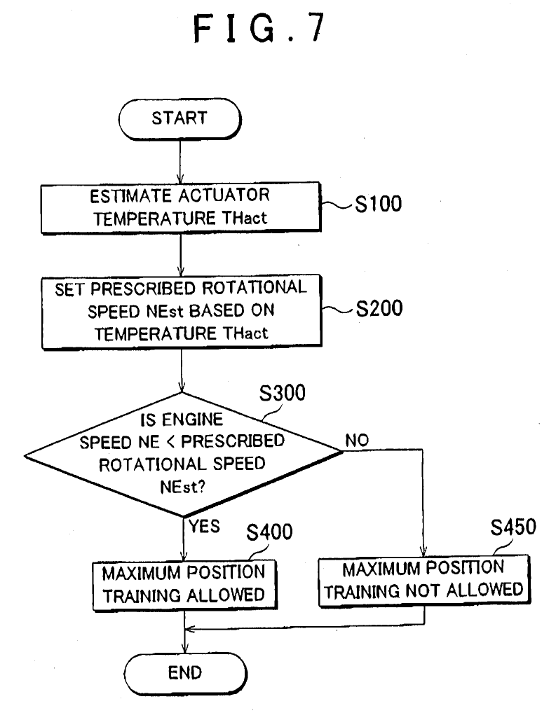

Therefore, with the present embodiment, the maximum position learning is limited by the following limiting process, and thus the occurrence of mistaken learning is suppressed. The limiting process is described below while referring to FIG. 7. Note, FIG. 7 is a flowchart showing the flow for a limiting process series.

This process is repeatedly performed by the electronic control unit 60 when it is determined that the maximum position learning must be performed, for example, when the battery voltage is low and it is determined that an instantaneous interruption has occurred. At the start of this process, in step S100, the electronic control unit 60 estimates the temperature THact of the actuator 50 based on the engine coolant temperature THW or, in other words, the temperature of the brushless motor 52 and the exchange mechanism 51. Specifically, the temperature THact of the actuator 50 that is mounted in proximity to the cylinder head 20 is estimated to be high when the engine coolant temperature THW is high.

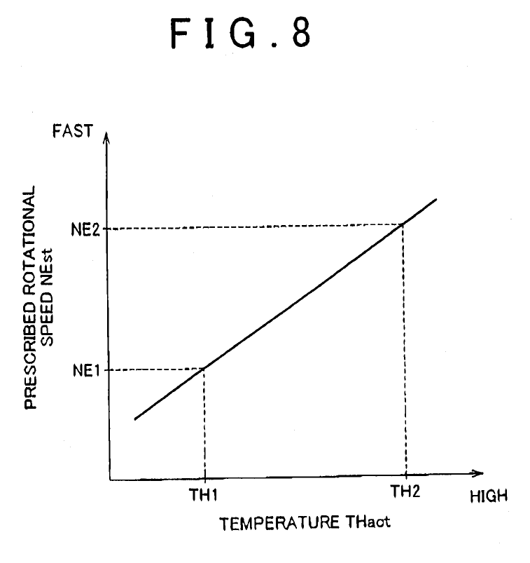

Furthermore, proceeding to step S200, a prescribed rotational speed NEst is set to an engine speed NE at which performing the maximum position learning is forbidden based on the estimated temperature THact. The prescribed rotational speed NEst is set by referring to an operation map prerecorded in the ROM based on the value for the engine speed NE where the maximum position learning can be performed while suppressing the occurrence of mistaken learning due to insufficient driving force. The operation map is set such that the prescribed rotational speed NEst is slower when the temperature THact estimated in step S100 is lower as shown in FIG. 8.

After the prescribed rotational speed NEst is set in step S200, the process proceeds to step S300, and a determination is made as to whether or not the engine speed NE is smaller than the prescribed rotational speed NEst. If it is determined in step S300 that the engine speed NE is slower than the prescribed rotational speed NEst (YES in step S300), the process proceeds to step S400, the maximum position learning is allowed, and this process is temporarily exited.

On the other hand, if it is determined in step S300 that the engine speed NE is equal to or faster than the prescribed rotational speed NEst (NO in step S300), the process proceeds to step S450, the maximum position learning is forbidden, and this process is temporarily exited.

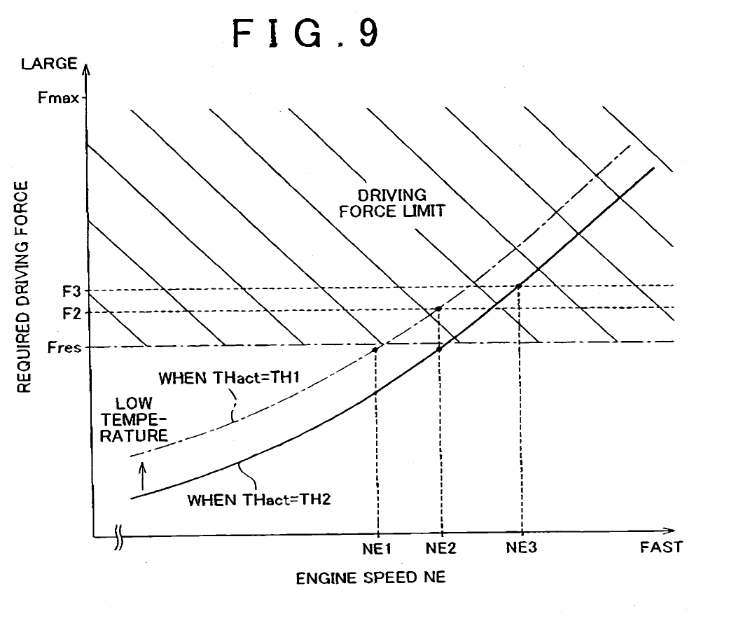

By repeatedly performing this process, the maximum position learning is forbidden when the engine speed NE is equal to or greater than the prescribed rotational speed NEst. The action of performing this process is described while also referring to FIG. 9. Note, FIG. 9 is a graph showing the relationship between the engine speed NE and the driving force required for performing the maximum position learning, wherein the solid line represents the driving force required when the temperature THact of the actuator 50 is at the temperature TH2 shown in FIG. 8, and the dashed line represents the driving force required when the temperature TI-tact of the actuator 50 is at a temperature TH1 which is lower than TH2.

As shown by the slashed lines in FIG. 9, during the maximum position learning, the driving force of the brushless motor 52 is limited to the driving force Fres that is approximately half of the maximum driving force Fmax, and the brushless motor 52 is driven to produce a fixed driving force Fres. As shown by the solid line in FIG. 9, if the maximum position learning is performed when the temperature THact of the actuator 50 is TH2 and the engine speed NE is NE3, the driving force Fres is smaller than the driving force F3 required for the maximum position learning, and therefore there is a possibility that the control shaft 340 stops during operation and mistaken learning occurs.

However, with the internal combustion engine of the present embodiment, if the temperature THact of the actuator 50 is TH2, the prescribed rotational speed NEst where the maximum position learning is forbidden will be set to NE2 by limit processing. As a result, when the engine speed NE is NE3, which is larger than NE2, the maximum position learning cannot be performed.

Furthermore, if the temperature THact of the actuator 50 is low, losses in the driving force will be even higher when moving the movable part, even when at the same engine speed NE, because of an increase in the friction of the oil seal parts and an increase in the viscosity of the lubricating oil provided to the actuator 50. Therefore, if the temperature THact of the actuator 50 is at TH1 which is below TH2, the driving force required for performing the maximum position learning will be higher as shown by the dashed line in FIG. 9.

Therefore, if the temperature THact of the actuator 50 is TH1 which is lower than TH2, as shown in FIG. 9, even if the maximum position learning is performed at the conditions where the engine speed NE is NE2, the driving force Fres is smaller than the driving force F2 required for the maximum position learning, and therefore there is a possibility that the driving force becomes insufficient, the control shaft 340 stops during operation, and mistaken learning occurs.

On this point, with the internal combustion engine of the present embodiment, when the temperature THact of the actuator 50 is at TH1, as shown in FIG. 8, due to the aforementioned limiting process, the prescribed rotational speed NEst where the maximum position learning is forbidden is set to NE1 which is even smaller than NE2. As a result, when the engine speed NE is NE2 which is larger than NE1, the maximum position learning will be forbidden.

The following effects can be achieved by the present embodiment as described above. (1) When the engine speed is high, the loss of driving force when moving the control shaft 340 will be high and a large driving force will be required when performing the maximum position learning, the maximum position learning is forbidden. Therefore, the problem that the driving force becomes insufficient, the control shaft 340 stops prematurely, and this stopping position is mistakenly learned as the Hi end can be avoided. In this manner, with the aforementioned present embodiment, it becomes possible to suppress the occurrence of mistaken learning due to insufficient driving force during the maximum position learning.

(2) If the temperature THact of the actuator 50 is low, losses in the driving force will be even higher when moving the control shaft 340, even when at the same engine speed NE, because of an increase in friction of the oil seal parts and an increase in the viscosity of the lubricating oil provided to the actuator. Therefore, the engine speed NE where the maximum position learning can be performed while suppressing the occurrence of mistaken learning is lower when the temperature THact of the actuator 50 is lower. Therefore, with the present embodiment, the temperature THact of the actuator 50 is estimated and the prescribed rotational speed NEst where the maximum position learning is forbidden is set to a smaller value when the estimated temperature THact is lower. As a result, the prescribed rotational speed NEst where the maximum position learning is forbidden can be set corresponding to the possibility of occurrence of mistaken learning due to insufficient driving force.

(3) When performing the maximum position learning, the cumulative movement of the control shaft 340 or, in other words, the stroke count value S, cannot be accurately determined, and thus the distance to the Hi end cannot be accurately determined. Therefore, if the control shaft 340 is driven by a large driving force, there is a possibility that the impact when the Hi end stopper 343 contacts the cylinder head 20 and the control shaft 340 stops is extremely large, and the lift amount change mechanism 300 and the actuator 50 that drives it is therefore damaged. On this point, with the present embodiment, the impact when the control shaft 340 stops can be minimized by limiting the driving force of the brushless motor 52 during the maximum position learning, and therefore damage to the lift amount change mechanism 300 and the actuator 50 can be suppressed. However, when a construction is used where the driving force of the brushless motor is limited during the maximum position learning in this manner, there is a higher possibility that the control shaft 340 will stop because of insufficient driving force even though the Hi end has not been reached, and therefore the wrong position will be learned as the Hi end. On this point, with the present embodiment, a construction that forbids the maximum position learning based on the engine speed NE is also utilized, and therefore even if the driving force of the brushless motor 52 is limited during the maximum position learning, the occurrence of mistaken learning caused by insufficient driving force can be suppressed.

Note, the aforementioned embodiment can be appropriately altered and can also have the following forms.

With the present embodiment, a construction where the opening degree of the throttle valve 33 is changed and the amount of air intake GA is regulated based on the accelerator operation amount ACCP during the maximum position learning has been shown, but a construction where the amount of air intake GA is not regulated by the throttle valve 33 can also be implemented. However, during the maximum position learning, the maximum lift amount of the intake valve 31 successively increases, so there is concern that the engine speed NE will increase. Therefore, if the amount of air intake GA is not regulated by the throttle valve 33, a construction can be utilized where the throttle valve 33 is maintained in a fully closed condition during the maximum position learning, and thus an increase in engine speed NE due to an increase in the maximum lift amount of the intake valve 31 is suppressed. Note, even if a construction is utilized where the throttle valve 33 is maintained in a fully closed condition during the maximum position learning, there is a case in which the engine speed NE increase even though the amount of air intake GA is limited, such as when the maximum position learning is performed when driving while using engine braking. Therefore, even when this construction is used, by using the control apparatus according to the above embodiment, it is possible to forbid the maximum position learning when the engine speed NE is equal to or above a prescribed rotational speed NEst and suppress the occurrence of mistaken learning caused by insufficient driving force during the maximum position learning.

Furthermore, the control apparatus of the aforementioned embodiment can be applied to an internal combustion engine in which the throttle valve 33 is maintained in a fully open condition during the maximum position learning in a manner similar to that during normal engine operation, or to an internal combustion engine that is not equipped with a throttle valve 33, and in which the maximum position learning is performed. However, if the amount of air intake GA is not limited during the maximum position learning in this manner, the maximum lift amount of the intake valve 31 successively increases in conjunction with the maximum position learning, the amount of air intake GA will increase, and the engine speed NE will also increase. Therefore, if this construction is used, the conditions for performing the maximum position learning are set so that the maximum position learning is performed under conditions where the engine speed NE will not increase even though the amount of intake air GA increases in conjunction with performing the maximum position learning, such as during fuel cutoff or the like. Note, even if the conditions for performing the maximum position learning are set in this manner, the engine speed NE might increase when performing the maximum position learning or the like when driving while using engine braking. However, the occurrence of mistaken learning caused by insufficient driving force during the maximum position learning can be suppressed by implementing the control apparatus of the aforementioned embodiment and forbidding the maximum position learning to be performed when the engine speed NE is equal to or above a prescribed rotational speed NEst.

With the aforementioned embodiment, a construction has been shown where a limiting process is performed and a determination is made whether or not to permit the maximum position learning to be performed, when it is determined that the maximum position learning is required such as when it is determined that the battery voltage has dropped and an instantaneous interruption has occurred. However, the control apparatus of the aforementioned embodiment can be implemented and the aforementioned limiting process can be performed even for the case where the maximum position learning is periodically performed during engine operation. Specifically, when it is determined by using a limiting process whether or not the maximum position learning should be performed regardless the conditions in which the maximum position learning is performed it is possible to suppress the occurrence of mistaken learning caused by insufficient driving force when the maximum position learning is performed.

Although a construction has been shown where the driving force of the brushless motor 52 is limited to a driving force Fres that is approximately half of the maximum driving force Fmax when performing the maximum position learning, the driving force Fres during the maximum position learning can also be changed as appropriate. The driving force should be limited to a level where the impact is minimized and damage to the actuator 50 is suppressed when the control shaft 340 stops in conjunction with the maximum position learning.

Furthermore, even when the driving force is not limited in this manner during the maximum position learning, the occurrence of mistaken learning caused by insufficient driving force can be suppressed by implementing the control apparatus of the aforementioned embodiment.

Although a construction has been shown where the temperature THact of the actuator 50 is estimated based on the engine coolant temperature THW, the method of estimating the temperature THact of the actuator 50 can be changed as appropriate. For example, a construction can also be implemented where a temperature sensor is provided to directly detect the temperature of the actuator 50.

Furthermore, the temperature of the internal combustion engine varies because of the heat of combustion, but the heat of combustion changes in amount based on the amount of air intake GA. Therefore, a construction can be implemented that uses the cumulative value for the amount of air intake GA of the internal combustion engine during the latest prescribed period of time as a correlation value related to the temperature THact of the actuator 50 and estimate that the temperature THact of the actuator 50 is high when this cumulative value is high.

In addition, if the lubricating oil that is supplied to the actuator 50 is supplied to lubricate the piston 12 that moves back and forth in the cylinder 11, and the lubricating oil supplied to the actuator 50 has a strong correlation to the temperature of the combustion chamber 13, the temperature THact of the actuator 50 will be sensitive and vary corresponding to current engine combustion conditions. Therefore, in this case, both the engine coolant temperature THW and the cumulative value for the amount of air intake GA during the latest prescribed period of time can be used as a correlation value related to the temperature THact of the actuator 50 in order to estimate the temperature THact of the actuator 50. In other words, the engine coolant temperature THW has a strong correlation to the average temperature of the overall internal combustion engine, but the cumulative value for the amount of air intake GA tends to have a strong correlation to the localized temperature changes in proximity to the combustion chamber 13. Therefore, with a construction that uses both the engine coolant temperature THW and the cumulative value for the amount of air intake as correlation values related to the temperature THact of the actuator 50, the temperature THact of the actuator 50 can be more precisely estimated by taking this tendency into account.

Note, the cumulative value for the amount of air intake may be estimated based on the cumulative value for the amount of fuel injected which has a strong correlation to the cumulative value for the amount of air intake, to estimate the temperature THact of the actuator 50.

Although a construction has been shown where the temperature THact of the actuator 50 is estimated and the prescribed rotational speed NEst where the maximum position learning is not allowed is changed based on the temperature THact of the actuator 50, a configuration may be adopted in which the value for the prescribed rotational speed NEst is set beforehand to a fixed value without changing the prescribed rotational speed NEst, and the maximum position learning is performed. Note, if this construction is used, the prescribed rotational speed NEst should be set to a value small enough to suppress the occurrence of mistaken learning caused by insufficient driving force even when the temperature THact of the actuator 50 is low and losses to the driving force when driving the control shaft 340 are high.

The lift amount change mechanism 300 described in connection with the aforementioned embodiment is one example and other constructions can be used so long as a lift amount change mechanism that changes the maximum lift amount of the intake valve 31 by moving a movable part is provided, and it is an internal combustion engine control apparatus that detects the maximum lift amount based on the cumulative movement of the movable part from the base position.

Furthermore, the method of calculating the cumulative movement of the control shaft 340 based on the pulse signals output from the position sensors S1, S2 and then estimating the maximum lift amount is one example of a detecting means for detecting the maximum lift amount based on the relative movement from the base position, and this means can be changed as appropriate.

1-8. (canceled)

9. A control method for an internal combustion engine having:
a lift amount change mechanism that moves a movable part by an actuator and changes a maximum lift amount of an intake valve;
a detecting portion that sets a base position based on a movable limit position where the maximum lift amount is largest and detects the maximum lift amount based on a cumulative movement of the movable part from the base position; and
a learning portion that drives the actuator such that the maximum lift amount increases and performs maximum position learning to correct the cumulative movement by learning a position where the movable part stops as a movable limit position, comprising:
estimating a temperature of the actuator;
setting a prescribed rotational speed to a slower speed when the estimated temperature of the actuator is lower; and
forbidding the maximum position learning to be performed by the learning portion when an engine speed is above the prescribed rotational speed.

10. An internal combustion engine control apparatus, comprising:
a lift amount change mechanism that changes a position of a movable part by an actuator and changes a maximum lift amount of the intake valve; and
a controller, wherein
the controller includes:
a detecting portion that sets a base position based on a movable limit position where the maximum lift amount is largest, and detects the maximum lift amount based on a cumulative movement of the movable part from the base position;
a learning portion that drives the actuator such that the maximum lift amount increases and performs maximum position learning to correct the cumulative movement by learning a position that the movable part stops at as the movable limit position; and
a forbidding portion that forbids the maximum position learning to be performed by the learning portion when a rotational speed of the engine is above a prescribed rotational speed.

11. The internal combustion engine control apparatus according to claim 10, further comprising a temperature estimating portion that estimates a temperature of the actuator, wherein the prescribed rotational speed is set to a smaller value when the temperature of the actuator as estimated by the temperature estimating portion is lower.

12. The internal combustion engine control apparatus according to claim 11, wherein the temperature estimating portion estimates the temperature of the actuator based on a temperature of an engine coolant.

13. The internal combustion engine control apparatus according to claim 11, wherein the temperature estimating portion estimates the temperature of the actuator based on an air intake cumulative value of the internal combustion engine during a latest prescribed time period.

14. The internal combustion engine control apparatus according to claim 10, further comprising a limiting portion that limits a driving force of the actuator while performing the maximum position learning.

15. The internal combustion engine control apparatus according to claim 10, further comprising a throttle opening degree adjusting portion that adjusts an opening degree of a throttle valve, wherein the throttle opening degree adjusting portion regulates an intake air quantity by adjusting the opening degree of the throttle valve according to an accelerator operation amount such that the throttle opening degree increases as the accelerator operation amount increases during the maximum position learning.

16. The internal combustion engine control apparatus according to claim 15, wherein the throttle opening degree adjusting portion maintains the throttle valve in a fully closed condition during the maximum position learning.

17. The internal combustion engine control apparatus according to claim 10, wherein the maximum position learning is performed when power supplied to the control apparatus is momentarily disrupted.
